(19) United States
(12) Patent Application Publication
(10) Pub. No.: US 2009/0321593 A1
(43) Pub. Date: Dec. 31, 2009

(54) Camera Guiding Device

(76) Inventor: Ulisse Foddis, Altenstadt/Iller (DE)

Correspondence Address: LERNER GREENBERG STEMER LLP, P O BOX 2480, HOLLYWOOD, FL, 33022-2480, US

(21) Appl. No.: 12/375,994

(22) PCT Filed: Mar. 15, 2007
(86) PCT No.: PCT/DE07/00489

§ 371 Date: May 20, 2009

(30) Foreign Application Priority Data
Aug. 1, 2006 (DE) 10 2006 036 126.1

(51) Int. Cl. G03B 17/56; F16M 11/04

(52) U.S. Cl. 248/187.1

(57) ABSTRACT

A camera guiding device, in particular for a camcorder or a digital camera, includes a camera holding platform to be fixed thereon, for supporting the camera. At least one horizontal element projects away from the camera holding platform and at least one vertical element projects up from the horizontal element. A handle for guiding the camera guiding device is connected to the vertical element, directly or through a further horizontal element.

The invention relates to a camera guiding device, in particular for a camcorder or a digital camera, comprising a camera holding platform for supporting the camera that can be fixed thereon, comprising at least one horizontal element projecting away from the camera holding platform and at least one vertical element projecting up from said horizontal element and comprising a handle for guiding the camera guiding device, wherein the handle is connected to the vertical element directly or via a further horizontal element.

Modern cameras follows the trend for miniaturisation and the use of materials which are as light as possible. This leads to cameras, in particular so-called camcorders or digital cameras, having become so small and light that they are no longer able to be easily guided three-dimensionally, because space is scarcely possible any more on the housing for grasping or handling for a shake-free camera guidance, with concentration on the subject.

It is an object of the invention to make available a camera guiding device which makes possible an improved handling of a camera, in particular of a camcorder or of a digital camera.

This problem is solved by a camera guiding device according to the features of Claim 1.

According to the invention, a camera guiding device is proposed, in particular for a camcorder or a digital camera, comprising a camera holding platform for supporting the camera that can be fixed thereon, comprising at least one horizontal element projecting away from the camera holding platform and at least one vertical element projecting up from said horizontal element, and comprising a handle for guiding the camera guiding device, wherein the handle is connected to the vertical element directly or via a further horizontal element.

Through the handle, the movement of the camera, mounted on the camera holding platform, is possible with a shake-free dynamic movement, without there being a fear of deflection by inadvertent pressing of buttons on the camera, which is to be avoided. The camera guiding device can likewise be securely caught hold of on the horizontal and vertical elements, which makes various adjustment positions possible.

According to a particularly preferred development of the invention, provision is made that a fastening means or an engagement for such a means is provided for cooperation with a corresponding counterpart on the camera at a fastening point at or on the camera holding platform. Hereby, a secure reversible mounting of the camera is possible on the camera holding platform.

Preferably, the handle is arranged over the fastening point of the fastening means on the camera holding platform.

According to a further preferred development of the invention, the handle runs substantially parallel to the camera holding platform which is, in particular, constructed so as to be flat.

According to a further development of the invention, provision is made that the handle is arranged centrally over the fastening point of the fastening means on the camera holding platform. Hereby, the camera is situated optimally in the centre of gravity directly under the handle, which allows a secure guidance.

Advantageously, two horizontal elements are provided, projecting oppositely away from the camera holding platform, in which respectively a vertical element projects up therefrom, with a further horizontal element being provided, which connects both vertical elements with each other, the handle being provided centrally on the horizontal element.

Advantageously, the fastening means is arranged in or beneath the centre of gravity of the camera.

The vertical element, for holding the camera guiding device, is advantageously formed by recessed grips or an elastic covering.

Preferably, at least one equipment mounting, in particular a flash socket, is provided on the further horizontal element.

In particular on the underside of the camera holding platform, according to a further development of the invention, a tripod fastening means or an engagement for such a fastening means for cooperation with a tripod is provided.

To protect the camera and to make as many possibilities for gripping as possible, advantageously provision is made that the horizontal element(s), the vertical element(s) and the further horizontal element form a frame around a camera which is mounted on the camera holding platform.

Advantageously, to adapt to various geometries and/or centres of gravity of cameras which are to be mounted, provision is made that the camera holding platform is mounted on the horizontal element so as to be displaceable along it and so as to be able to be secured on it. Following this, an elongated hole can be provided, which cooperates with a detachable fastening.

According to a particularly preferred further development of the invention, a lateral handle is provided, which is connected to the vertical element, with the lateral handle running substantially perpendicularly to the camera holding platform.

Advantageously, the lateral handle is swivellable in one plane by means of a joint which is able to be secured, to which plane the camera holding platform runs substantially perpendicularly.

According to a further development of the invention, the fastening means is guided displaceably along the camera holding platform in particular in an elongated hole formed thereon, with in particular the fastening means, on cooperation with the corresponding counterpart on the camera, securing this in its position in the elongated hole.

According to a further advantageous development of the invention, a removable pistol handle is provided, which is able to be fastened on the side of the camera holding platform or of the horizontal element facing away from the camera.

An accessory socket is advantageously provided on a horizontal element, on which in particular a lighting device can be fastened. Lighting devices in the sense of the invention comprise here all kinds of equipment which are able to be used as accessories for cameras or camcorders.

The invention is further described below with the aid of the drawings. In detail, the diagrammatic illustration shows in:

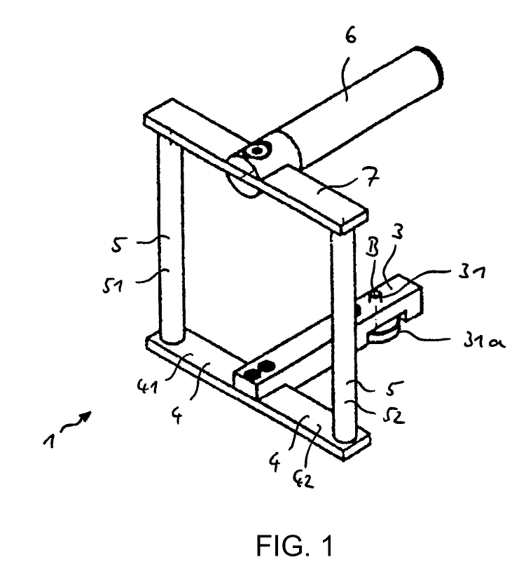

FIG. 1 a diagrammatic top view onto a camera guiding device according to the invention, from obliquely above,

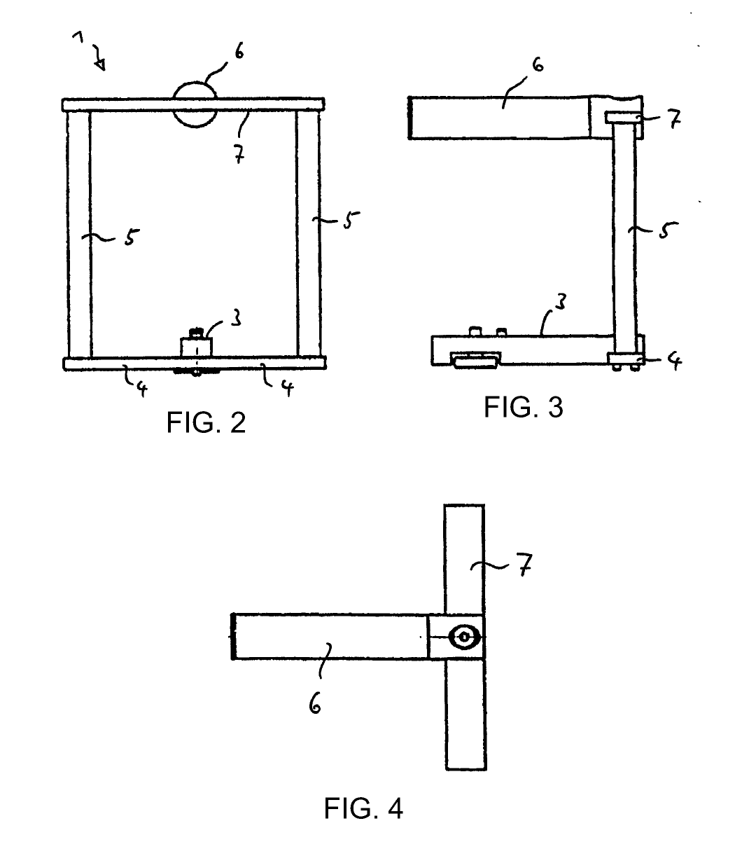

FIG. 2 a diagrammatic view from the front onto the camera guiding device of FIG. 1,

FIG. 3 a diagrammatic side view of the camera guiding device of FIG. 1,

FIG. 4 a diagrammatic view from above onto the camera guiding device of FIG. 1,

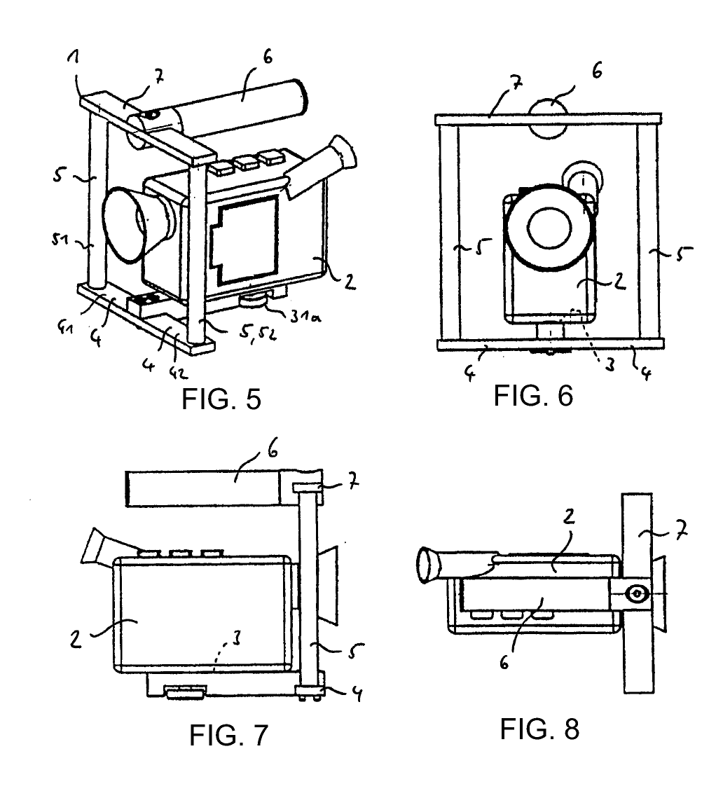

FIG. 5 a diagrammatic top view from obliquely above onto the camera guiding device according to the invention of FIG. 1 with a video camera mounted therein,

FIG. 6 a diagrammatic view from the front onto the camera guiding device of FIG. 5,

FIG. 7 a diagrammatic side view of the camera guiding device of FIG. 5,

FIG. 8 a diagrammatic view from above onto the camera guiding device of FIG. 5,

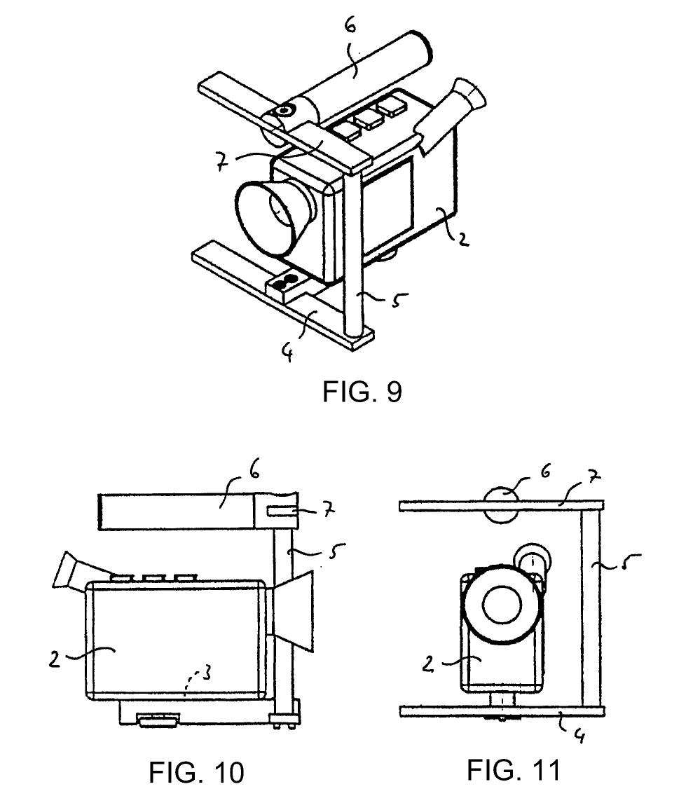

FIG. 9 a diagrammatic top view from obliquely above onto a modification of the camera guiding device according to the invention with a video camera mounted therein,

FIG. 10 a diagrammatic side view of the camera guiding device of FIG. 9,

FIG. 11 a diagrammatic view from the front onto the camera guiding device of FIG. 9,

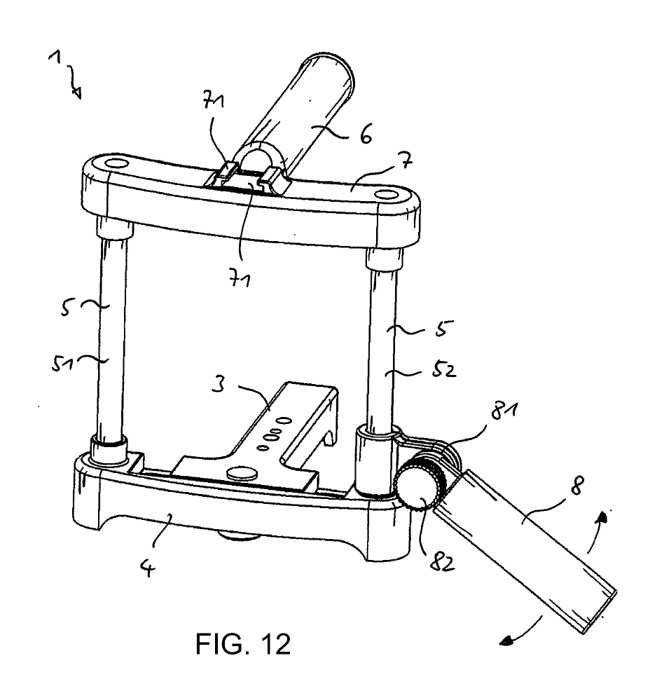

FIG. 12 a diagrammatic view from the front onto a further embodiment of a camera guiding device with an additional lateral handle,

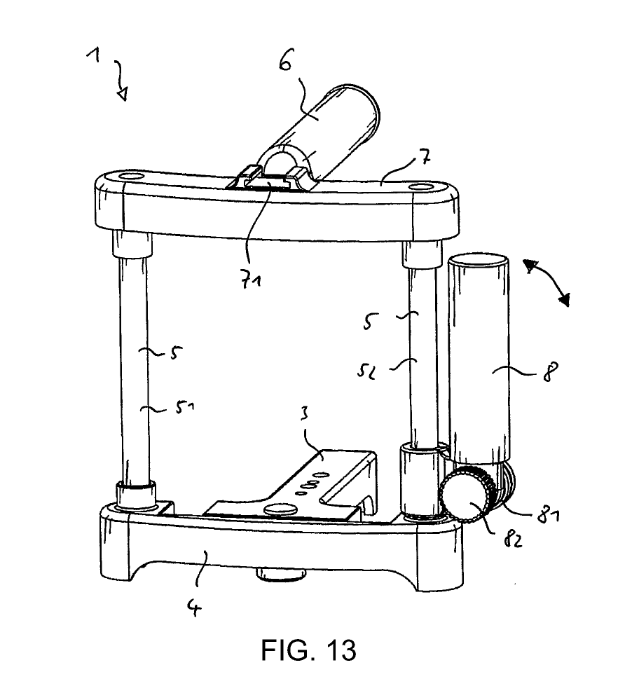

FIG. 13 a diagrammatic view onto the camera guiding device of FIG. 12 with folded-in lateral handle,

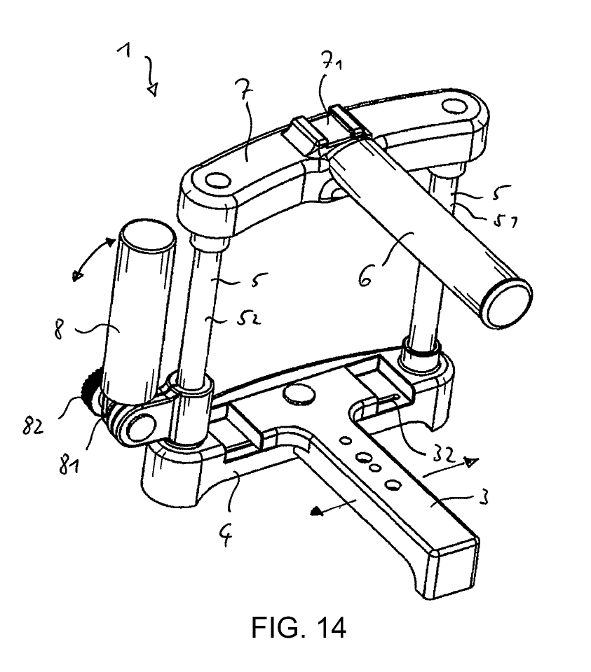

FIG. 14 a diagrammatic view from obliquely above onto the camera guiding device of FIG. 12,

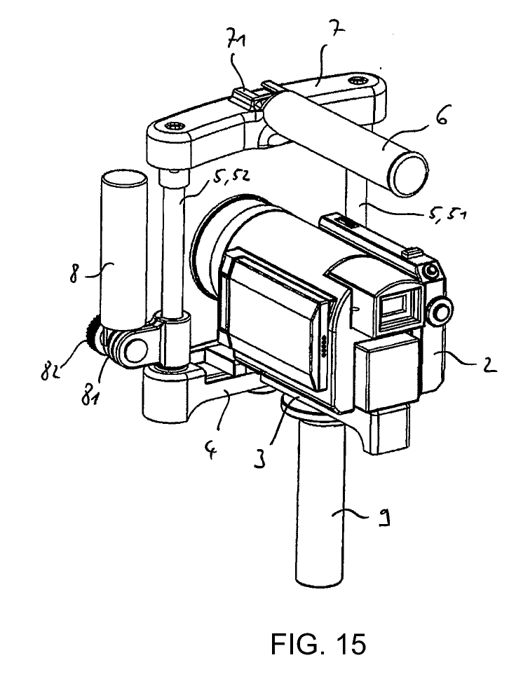

FIG. 15 a diagrammatic top view from the rear onto the camera guiding device of FIG. 12 with video camera and pistol handle mounted thereon, and

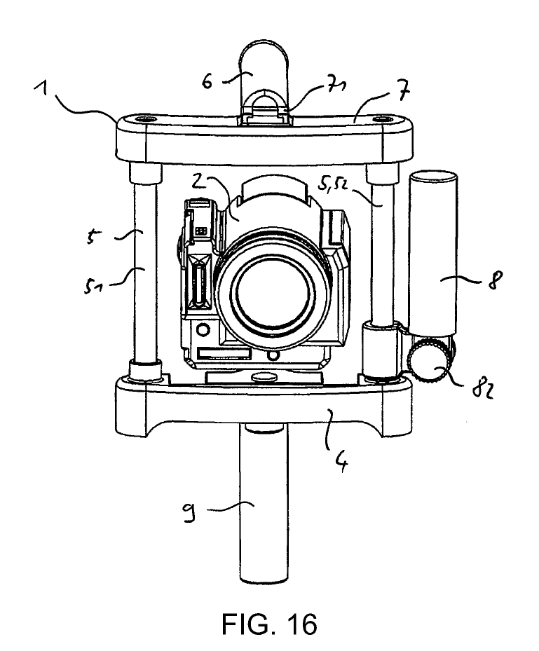

FIG. 16 a diagrammatic top view from the front onto the camera guiding device of FIG. 15.

Identical reference numbers in the figures designate identical or identically acting elements.

FIG. 1 shows a diagrammatic view of a camera guiding device 1 according to the invention. By a standardized screw as fastening means 31 at a fastening point B on the camera holding platform 3, provided to support the camera which is able to be fastened thereon, the camera guiding device can receive all current camcorders or digital cameras and also classic film cameras. A knurled wheel 31a is provided for loosening and tightening the screw which cooperates with a thread on a camera.

Two horizontal elements 4 (41 and 42) project oppositely away from the camera holding platform 3. At the ends of these, respectively vertical elements 5 (51 and 52) are provided, projecting up therefrom, which carry a further horizontal element 7 on which a handle 6 is arranged centrally over the fastening point B of the fastening means 31. The handle 6 runs here substantially parallel to the camera holding platform 3.

The vertical elements 5 can be provided, for holding the camera guiding device 1, with recessed grips or an elastic covering.

FIG. 2 to FIG. 4 show the camera guiding device from the front, from the side and from above.

In FIG. 5 to FIG. 8 a camcorder 2, mounted in the camera guiding device 1 on the camera holding platform 3, is shown in various directions of view.

On the camera guiding device 1, one or more so-called flash sockets can be provided in particular on the further horizontal element 7.

It is also advantageous, if a removable screen is present on the camera, to be able to fasten this on a fastening means provided on the camera guiding device, in order to ensure a better view of it.

In FIG. 9 a variant of the camera guiding device 1 is shown, in which only one vertical element 5 is present.

To balance out the centre of gravity in this or the variant with two vertical elements, provision can be made to provide variable weights, in order to make it possible for the camera guiding device to lie in the hand in an optimum manner.

FIG. 10 shows a view of the variant of the camera guiding device of FIG. 9 in a side view and FIG. 11, finally, in a view from the front.

FIG. 12 shows a further embodiment of the invention, in which the camera guiding device 1 which is shown is provided with an additional lateral handle 8.

Additionally also an accessory socket 71 is provided on a horizontal element 7, on which for example a flash can be fastened as additional lighting device. An accessory socket is to be understood here to be a device on which accessories such as external flash equipment, lamps, view-finders or water balances can be attached by means of a special base/foot.

The lateral handle 8 is provided connected with the vertical element 5 and runs substantially perpendicularly to the camera holding platform 3.

The lateral handle 8 is constructed so as to be swivellable for optimum adjustment, and for this is connected with the vertical element 52 by means of a joint 81 which is able to be secured. In the example which is shown, the lateral handle is swivellable in a plane to which the camera holding platform 3 runs substantially perpendicularly, see also FIG. 13 in this respect, in which the lateral handle is secured in another position by means of a setscrew 82 locking the joint 81.

FIG. 14 shows the embodiment of FIGS. 12 and 13 from a perspective from obliquely above. In this position, the further feature of the embodiment can be seen, according to which the camera holding platform 3 is mounted on the horizontal element 4 so as to be displaceable along the latter and so as to be able to be secured thereon. For this, an elongated hole with setscrew is provided.

FIGS. 15 and 16 show the embodiment of FIG. 12 to 14 with a camcorder 2 mounted thereon, from a view from the front (FIG. 15) and from the rear (FIG. 16).

A mounted, removable pistol handle 9 is shown here, which is fastened on the side of the camera holding platform 3 facing away from the camera. Hereby, a further improvement to handling is provided through a further grip possibility.

### LIST OF REFERENCE NUMBERS

1 camera guiding device
2 camcorder
3 camera holding platform
31 fastening means
31a knurled wheel
32 elongated hole
4 horizontal element
41 horizontal element
42 horizontal element
5 vertical element
51 vertical element
52 vertical element
6 handle
7 horizontal element
71 accessory socket
8 lateral handle
81 joint
82 setscrew
9 pistol handle
B fastening point

1-17. (canceled)

18. A camera guiding device, in particular for a camcorder or a digital camera, the camera guiding device comprising:
a camera holding platform for supporting the camera to be fixed on said camera holding platform;
at least one horizontal element projecting away from said camera holding platform;
at least one vertical element projecting up from said horizontal element; and
a handle connected to said vertical element for guiding the camera guiding device.

19. The camera guiding device according to claim 18, which further comprises a further horizontal element connecting said handle to said vertical element.

20. The camera guiding device according to claim 18, wherein said handle is directly connected to said vertical element.

21. The camera guiding device according to claim 18, which further comprises a fastening device or engagement therefor disposed at a fastening point or on said camera holding platform and configured to cooperate with a corresponding counterpart on the camera.

22. The camera guiding device according to claim 21, wherein said handle is disposed over said fastening point of said fastening device.

23. The camera guiding device according to claim 18, wherein said handle is substantially parallel to said camera holding platform.

24. The camera guiding device according to claim 21, wherein said handle is disposed centrally over said fastening point of said fastening device.

25. The camera guiding device according to claim 18, wherein:
said at least one horizontal element includes two horizontal elements projecting oppositely away from said camera holding platform;
said at least one vertical element includes two vertical elements each projecting up from a respective one of said two horizontal elements;
a further horizontal element interconnects said two vertical elements; and
said handle is disposed centrally on said further horizontal element.

26. The camera guiding device according to claim 21, wherein said fastening device is disposed at or beneath a center of gravity of the camera.

27. The camera guiding device according to claim 18, wherein said vertical element for holding the camera guiding device is formed by recessed grips or an elastic covering.

28. The camera guiding device according to claim 19, which further comprises at least one equipment mounting or flash socket disposed on said further horizontal element.

29. The camera guiding device according to claim 18, which further comprises a tripod fastening device or engagement therefor configured for cooperation with a tripod.

30. The camera guiding device according to claim 29, wherein said tripod fastening device or engagement is disposed on an underside of said camera holding platform applied to the camera to be held.

31. The camera guiding device according to claim 19, wherein said at least one horizontal element, said at least one vertical element and said further horizontal element form a frame around a camera mounted on said camera holding platform.

32. The camera guiding device according to claim 18, wherein said camera holding platform is mounted and configured to be displaceable on and to be secured on said at least one horizontal element.

33. The camera guiding device according to claim 18, which further comprises a lateral handle being connected to said at least one vertical element and substantially perpendicular to said camera holding platform.

34. The camera guiding device according to claim 33, which further comprises a lockable joint at which said lateral handle swivels in a plane substantially perpendicular to said camera holding platform.

35. The camera guiding device according to claim 21, wherein said fastening device is guided displaceably along said camera holding platform.

36. The camera guiding device according to claim 35, wherein said camera holding platform has an elongated hole formed therein for displaceably guiding said fastening device.

37. The camera guiding device according to claim 36, wherein said fastening device cooperates with the corresponding counterpart on the camera for securing said fastening device in a position in said elongated hole.

38. The camera guiding device according to claim 18, which further comprises a removable pistol handle to be fastened on a side of said camera holding platform or of said at least one horizontal element facing away from the camera.

39. The camera guiding device according to claim 19, which further comprises an accessory socket disposed on said further horizontal element for fastening a lighting device.
